(19) United States
(12) Patent Application Publication
(10) Pub. No.: US 2025/0084960 A1
(43) Pub. Date: Mar. 13, 2025

(54) Under Cabinet Banana Hanger

(71) Applicant: John Giles, Marble Falls, TX (US)

(72) Inventor: John Giles, Marble Falls, TX (US)

(21) Appl. No.: 18/367,050

(22) Filed: Sep. 12, 2023

(51) Int. Cl. F16M 13/02

(52) U.S. Cl. CPC F16M 13/022

(57) ABSTRACT

An apparatus and method for hanging bananas under a cabinet without fasteners. All present methods and apparatuses require the user to mount the banana holder into a cabinet using metal fasteners, which leaves irreparable damage in the cabinet, or other methods require the user to use valuable countertop space to use a banana hanger that stands on top of the countertop.

### PRIOR ART

While there are various banana stands such as US 2015/0296979, they use up counter space which could be better utilized.

Then there are various hook and hanger systems such as U.S. Pat. Nos. 9,486,073 and 11,089,888, however, they require that the mechanism is permanently affixed to the cabinet it is attached to.

There is also U.S. Pat. No. 4,414,529 which is meant to be hung on a doorknob or handle and then the bananas hang from the apparatus. However, a device like this will result in bananas leaning up against the side of certain cabinets as opposed to freely hanging without contact.

### BACKGROUND OF THE INVENTION

Banana bunches need to be hung by their stems to prevent bruising and to prolong freshness. All present methods and apparatuses require the user to mount the banana holder into a cabinet using metal fasteners, which leaves irreparable damage in the cabinet, or other methods require the user to use valuable countertop space to use a banana hanger that stands on top of the countertop.

### SUMMARY OF THE INVENTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

As described herein, the term “pivotally connected” shall be used to describe a situation wherein two or more identified objects are joined together in a manner that allows one or both of the objects to pivot, and/or rotate about or in relation to the other object in either a horizontal or vertical manner.

As described herein, the term “removably coupled” and derivatives thereof shall be used to describe a situation wherein two or more objects are joined together in a non-permanent manner so as to allow the same objects to be repeatedly joined and separated.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

As such, it should be noted that a plurality of hardware, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

The present subject matter method and apparatus does not require fasteners that damage the cabinet, and does not take up any countertop space either, thereby solving two problems at once.

The apparatus is comprised of a horizontal top arm with a grip pad, a vertical front face, and a horizontal bottom hook, which is substantially parallel with the aforementioned horizontal top arm.

The bottom of the top arm rests horizontally from back to front on the top of the lowest shelf of a wall-mounted cabinet in such a way as to allow the weight of the bananas and hanger to be supported by the top of the aforementioned lowest shelf inside the cabinet.

The flat, vertical, front face of the apparatus continues from the foremost part of the horizontal top arm but turns downward and descends vertically between the lowest face of the cabinet frame and the back side of the cabinet door when the cabinet door is closed, and is thin enough as to not impede the closing of common cabinet doors.

The horizontal bottom hook continues from the bottom of the front face by turning back towards the wall and dips down and then back up beneath the top arm and terminates under where the horizontal top arm started, so as to create a receiver suspended a short distance from the bottom of the cabinet on which the user should place bananas to be stored. The bottom hook also comes to a point so as to fit between the stems of the bananas.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation.

The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom.

### DESCRIPTION OF DRAWINGS

FIG. 1 shows a top perspective view of the under cabinet banana hanger.

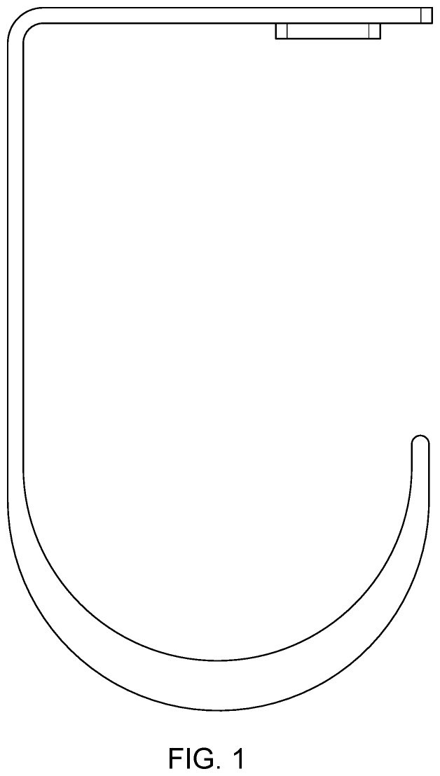

FIG. 2 shows a side view of the of the under cabinet banana hanger.

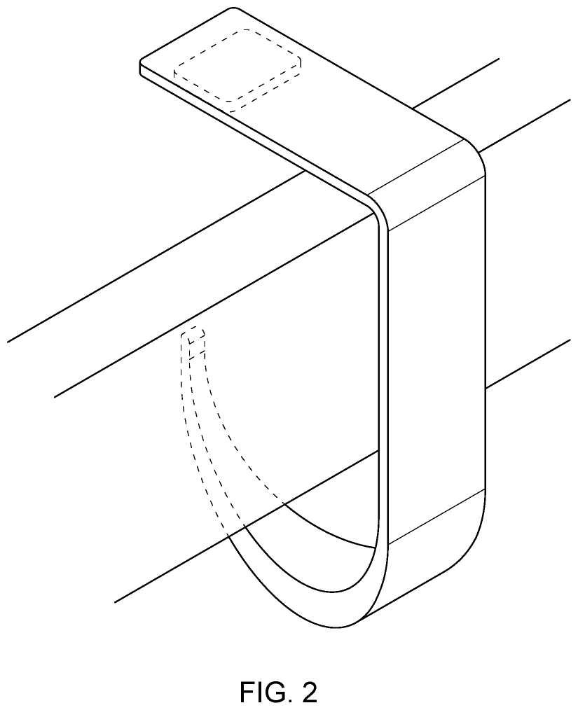

1. An under cabinet banana hanger comprising of a horizontal top arm, vertical front face, horizontal bottom hook, and a grip pad.

2. The under cabinet banana hanger comprising of the horizontal top arm, vertical front face, horizontal bottom hook, and the grip pad as in claim 1, wherein the grip pad is affixed to the horizontal top arm.

3. The under cabinet banana hanger comprising of the horizontal top arm, vertical front face, horizontal bottom hook, and the grip pad as in claim 1, wherein the horizontal top arm and grip pad rests on a cabinet shelf without any type of fasteners.

4. The under cabinet banana hanger comprising of the horizontal top arm, vertical front face, horizontal bottom hook, and the grip pad as in claim 1, wherein the vertical front face is thin enough to not impede the closing of common cabinet doors.

5. The under cabinet banana hanger comprising of the horizontal top arm, vertical front face, horizontal bottom hook, and the grip pad as in claim 1, wherein the horizontal bottom hook is substantially parallel to the horizontal top arm and turns back toward the wall so as to provide additional stability.

6. A method of manufacturing an under cabinet banana hanger comprising of a horizontal top arm, vertical front face, horizontal bottom hook, and a grip pad.

7. The method of manufacturing the under cabinet banana hanger comprising of the horizontal top arm, vertical front face, horizontal bottom hook, and the grip pad as in claim 6, wherein the grip pad is affixed to the horizontal top arm.

8. The method of manufacturing the under cabinet banana hanger comprising of the horizontal top arm, vertical front face, horizontal bottom hook, and the grip pad as in claim 6, wherein the horizontal top arm and grip pad rests on a cabinet shelf without any type of fasteners.

9. The method of manufacturing the under cabinet banana hanger comprising of the horizontal top arm, vertical front face, horizontal bottom hook, and the grip pad as in claim 6, wherein the vertical front face is thin enough to not impede the closing of common cabinet doors.

10. The method of manufacturing the under cabinet banana hanger comprising of the horizontal top arm, vertical front face, horizontal bottom hook, and the grip pad as in claim 6, wherein the horizontal bottom hook is substantially parallel to the horizontal top arm and turns back toward the wall so as to provide additional stability.
